(19) United States
(12) Patent Application Publication
(10) Pub. No.: US 2022/0061371 A1
(43) Pub. Date: Mar. 3, 2022

(54) COMPOSITIONS COMPRISING INSECT POWDER HAVING HIGH CALCIUM AND HIGH MAGNESIUM CONTENT

(71) Applicant: FLYING SPARK LTD., Ramat Gan (IL)

(72) Inventors: Keren KLES, Nes Ziona (IL); Eran GRONICH, Ramat Gan (IL)

(21) Appl. No.: 17/415,186

(22) PCT Filed: Dec. 18, 2019
(86) PCT No.: PCT/IL2019/051383

§ 371 Date: Jun. 17, 2021

Related U.S. Application Data
(60) Provisional application No. 62/781,029, filed on Dec. 18, 2018.

(51) Int. Cl. A23L 33/12; A23L 33/16

(52) U.S. Cl. CPC A23L 33/12; A23L 33/16

(57) ABSTRACT

The present invention is directed to a composition comprising an insect powder, wherein the insect powder comprises calcium in the amount of 800-3,200 mg/100 gr insect powder; magnesium in the amount of 230-900 mg/100 gr insect powder, or a combination thereof. The provided composition further comprises protein in an amount of 40-80% by weight of insect powder.

### CROSS REFERENCE TO RELATED APPLICATIONS

This application claims the benefit of priority of U.S. Provisional Patent Application No. 62/781,029 titled “COMPOSITIONS COMPRISING INSECT POWDER HAVING HIGH CALCIUM AND HIGH MAGNESIUM CONTENT”, filed Dec. 18, 2018, the contents of which is incorporated herein by reference in its entirety.

### FIELD OF THE INVENTION

The present invention is in the field of foodstuff comprising animal-derived products, including, but not limited to insect-derived products.

### BACKGROUND

Humanity faces a great challenge, that is how to feed the ever growing population, which is expected to exceed the 9 billion mark by 2040. The traditional livestock farming, which causes a destructive ecological impact on the environment, is: (a) using about 70% of land resources designated for agricultural; (b) a major contributor to greenhouse gas emission; (c) a significant water and land abuser; and (d) a producer of enormous amounts of organic waste.

Further to the above, animal-derived protein may pose harmful health-related effects, possibly due to the presence of hormones, antibiotics, and pesticides.

With this respect, insects are known to be a highly nutritious and a healthy food source, having high fat, protein, vitamin, fiber and mineral content.

### SUMMARY

The present invention, in some embodiments thereof, is directed to a composition comprising an insect powder rich with calcium, magnesium, or both. In some embodiments, the composition is an edible composition.

According to a first aspect there is provided a composition comprising an insect powder comprising: calcium at a concentration of 800-3,200 mg/100 gr insect powder; magnesium at a concentration of 230-900 mg/100 gr insect powder, or a combination thereof.

In some embodiments, the insect powder further comprises a protein at an amount of 40-80% by weight of the insect powder.

In some embodiments, the insect powder further comprises cholesterol in an amount of less than 0.25 mg/100 gr of the insect powder.

In some embodiments, the insect powder further comprises one or more compounds selected from the group consisting of: iron, phosphorus, potassium, sodium, and zinc.

In some embodiments, iron is present in an amount of 15-35 mg/100 gr of the insect powder.

In some embodiments, phosphorus is present in an amount of 1,000-2,800 mg/100 gr of the insect powder.

In some embodiments, potassium is present in an amount of 500-1,300 mg/100 gr of the insect powder.

In some embodiments, sodium is present in an amount of 1-200 mg/100 gr of the insect powder.

In some embodiments, zinc is present in an amount of 10-50 mg/100 gr of the insect powder.

In some embodiments, the insect powder further comprises one or more fatty acids selected from monounsaturated or polyunsaturated fatty acids.

In some embodiments, the monounsaturated fatty acid is selected from the group consisting of: palmitoleic acid, oleic acid, cis-11-octadecanoic acid, and myristoleic acid.

In some embodiments, the monounsaturated fatty acid is palmitoleic acid.

In some embodiments, 25-60% by weight of fatty acids within the insect powder are monosaturated fatty acids.

In some embodiments, 20-30% by weight of fatty acids within the insect powder are palmitoleic acid.

In some embodiments, the polyunsaturated fatty acid is any one of linoleic acid and linolenic acid.

In some embodiments, 0.1-10% by weight of fatty acids within the insect powder are polyunsaturated fatty acids.

In some embodiments, the powder comprises any one of: an extract, a homogenate, fractions thereof, and any combination thereof, derived from the insect.

In some embodiments, the insect powder is derived from any one of: a whole adult insect, an egg thereof, a pupae thereof, a larvae thereof, any portions thereof, and any combination thereof.

In some embodiments, the insect is Ceratitis capitate.

In some embodiments, the composition is an edible composition.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Further embodiments and the full scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE FIGURES

FIG. 1 is a flow chart, showing a non-limiting example of a growing process from eggs to larvae for product processing, on one hand, and a full life-cycle procedure used to maintain continuous egg supply, on the other hand.

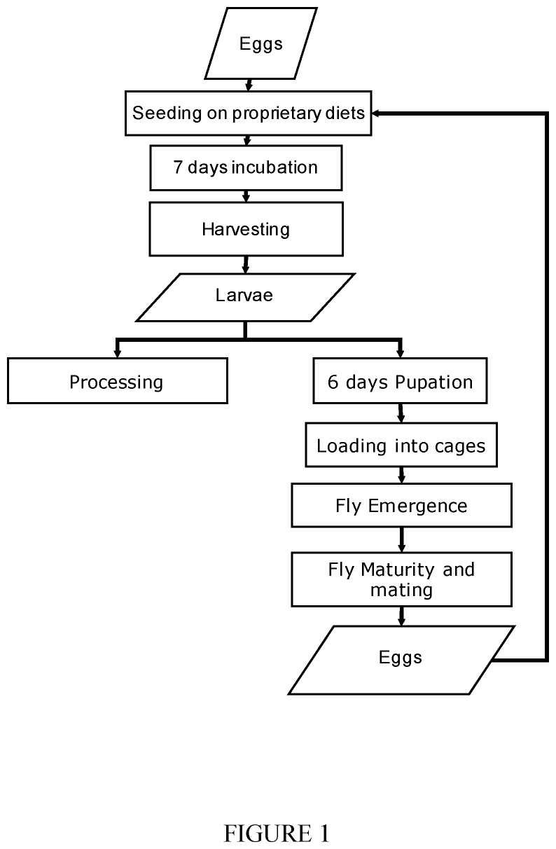

FIG. 2 is a flow chart, showing a non-limiting example of larvae processing into protein powder, and oil.

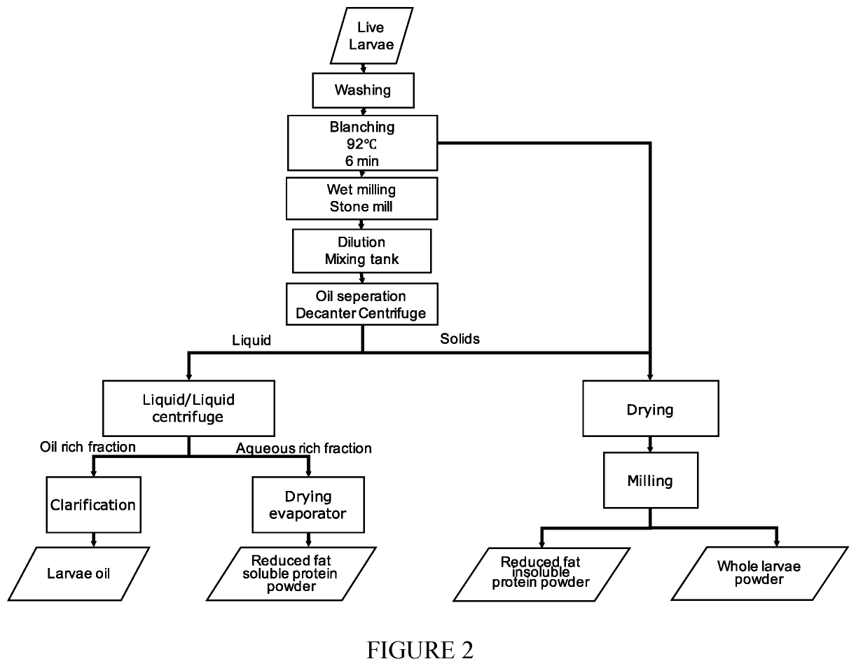

### DETAILED DESCRIPTION

According to some embodiments, there is provided a composition comprising an insect powder. In some embodiments, the present invention is directed to an edible composition. In some embodiments, the invention is directed to an insect edible product.

As used herein, the term “insect powder” refers to a powder or “flour” made from insects.

In some embodiments, the insect powder comprises an insect extract. In one embodiment, an extract is a dried extract. In an alternative embodiment, an extract is a wet extract. In some embodiments, the insect extract is extracted from a whole adult insect, an egg thereof, pupae thereof, larvae thereof, an organ thereof, any portion thereof, or any combination thereof. In some embodiments, the insect powder comprises an insect homogenate or a fraction thereof. In some embodiments, an insect homogenate comprises a homogenate of a whole insect, an egg thereof, pupae thereof, larvae thereof, an organ thereof, any portion thereof, or any combination thereof. In some embodiments, the insect homogenate is obtained by homogenization of a whole insect, an egg thereof, pupae thereof, larvae thereof, an organ thereof, any portion thereof, or any combination thereof. In some embodiments, the insect powder comprises a concentrate of solids. In some embodiments, the solids are whole fat solids. In some embodiments, the solids are reduced-fat solids. In some embodiments, the solids are derived from a whole insect, an egg thereof, pupae thereof, larvae thereof, an organ thereof, any portion thereof, or any combination thereof. In some embodiments, the insect powder comprises an insect extract or a fraction thereof. In some embodiments, the insect powder comprises a concentrated homogenate of an insect or a fraction thereof. In some embodiments, the solids are derived from an oil-free faction of an insect powder. In some embodiments, the insect powder is devoid of oil.

Methods of extraction, homogenization, and fractionation are common and would be apparent to a skilled artisan. Non-limited examples are given further below.

In some embodiments, an insect is a fly. In some embodiments, a fly is a fruit fly. In some embodiments, a fruit fly is the Mediterranean fruit fly, Ceratitis capitate. In some embodiments, a fruit fly is the oriental fruit fly, Bactrocera dorsalis.

In some embodiments, the composition of the invention comprises an insect powder derived from a fruit fly, Ceratitis capitate. In some embodiments, the composition of the invention comprises an insect powder derived from the Mediterranean fruit fly, Ceratitis capitate. In some embodiments, the composition of the invention comprises an insect powder derived from the oriental fruit fly, Bactrocera dorsalis.

According to some embodiments the composition comprises an insect powder as described herein comprising: calcium at the amount of 800-3,200 mg/100 gr of total insect powder; magnesium at the amount of 230-900 mg/100 gr of total insect powder, or a combination thereof.

In one embodiment, “gr of insect powder” is gr of total insect powder. In one embodiment, “gr of insect powder” is gr of whole insect powder.

In some embodiments, the insect powder comprises calcium in an amount ranging from 900-1,500 mg/100 gr of insect powder, 800-2,000 mg/100 gr of insect powder, 1,800-2,800 mg/100 gr of insect powder, 1,000-2,200 mg/100 gr of insect powder, 1,100-1,900 mg/100 gr of insect powder, 1,800-2,400 mg/100 gr of insect powder, 2,000-3,100 mg/100 gr of insect powder, 2,200-2,900 mg/100 gr of insect powder, 1,300-2,100 mg/100 gr of insect powder, 1,900-2,700 mg/100 gr of insect powder, 2,500-2,850 mg/100 gr of insect powder, 1,700-2,350 mg/100 gr of insect powder, or 2,850-3,500 mg/100 gr of insect powder. Each possibility represents a separate embodiment of the invention. In some embodiments, the insect powder comprises calcium in the amount of at least 800 mg/100 gr of insect powder, at least 900 mg/100 gr of insect powder, at least 1,000 mg/100 gr of insect powder, at least 1,250 mg/100 gr of insect powder, at least 1,500 mg/100 gr of insect powder, at least 1,750 mg/100 gr of insect powder, at least 2,000 mg/100 gr of insect powder, at least 2,200 mg/100 gr of insect powder, at least 2,400 mg/100 gr of insect powder, at least 2,600 mg/100 gr of insect powder, at least 2,800 mg/100 gr of insect powder, at least 3,000 mg/100 gr of insect powder, at least 3,500 mg/100 gr of insect powder, or any value or range therebetween. Each possibility represents a separate embodiment of the invention.

In some embodiments, the insect powder comprises magnesium in an amount ranging from 230-500 mg/100 gr of insect powder, 300-900 mg/100 gr of insect powder, 250-800 mg/100 gr of insect powder, 280-750 mg/100 gr of insect powder, 350-700 mg/100 gr of insect powder, 380-650 mg/100 gr of insect powder, 400-850 mg/100 gr of insect powder, 420-900 mg/100 gr of insect powder, 480-880 mg/100 gr of insect powder, 500-700 mg/100 gr of insect powder, 550-850 mg/100 gr of insect powder, 700-830 mg/100 gr of insect powder, or 750-1,000 mg/100 gr of insect powder. Each possibility represents a separate embodiment of the invention. In some embodiments, the insect powder comprises magnesium in the amount of at least 230 mg/100 gr of insect powder, at least 250 mg/100 gr of insect powder, at least 300 mg/100 gr of insect powder, at least 350 mg/100 gr of insect powder, at least 400 mg/100 gr of insect powder, at least 450 mg/100 gr of insect powder, at least 500 mg/100 gr of insect powder, at least 550 mg/100 gr of insect powder, at least 600 mg/100 gr of insect powder, at least 650 mg/100 gr of insect powder, at least 700 mg/100 gr of insect powder, at least 750 mg/100 gr of insect powder, at least 800 mg/100 gr of insect powder, at least 850 mg/100 gr of insect powder, at least 880 mg/100 gr of insect powder, at least 900 mg/100 gr of insect powder, at least 1 gr/100 gr of insect powder, or any value or range therebetween. Each possibility represents a separate embodiment of the invention.

In some embodiments, the insect powder further comprises a protein. In some embodiments, the insect powder comprises a protein in an amount ranging from 40-50% by weight of insect powder, 40-60% by weight of insect powder, 40-70% by weight of insect powder, 45-60% by weight of insect powder, 45-65% by weight of insect powder, 50-65% by weight of insect powder, 50-85% by weight of insect powder, 55-75% by weight of insect powder, 60-75% by weight of insect powder, or 65-80% by weight of insect powder. Each possibility represents a separate embodiment of the invention. In some embodiments, the insect powder comprises a protein in the amount of at least 40% by weight of insect powder, at least 45% by weight of insect powder, at least 50% by weight of insect powder, at least 55% by weight of insect powder, at least 60% by weight of insect powder, at least 65% by weight of insect powder, at least 70% by weight of insect powder, at least 80% by weight of insect powder, or any range or value therebetween. Each possibility represents a separate embodiment of the invention.

In some embodiments, the insect powder further comprises cholesterol. In some embodiments, the insect powder comprises cholesterol in the amount of less than 0.001 mg/100 gr of insect powder, less than 0.01 mg/100 gr of insect powder, less than 0.05 mg/100 gr of insect powder, less than 0.1 mg/100 gr of insect powder, less than 0.15 mg/100 gr of insect powder, less than 0.2 mg/100 gr of insect powder, less than 0.25 mg/100 gr of insect powder, less than 0.3 mg/100 gr, less than 0.5 mg/100 gr of insect powder, or any value or range therebetween. Each possibility represents a separate embodiment of the invention. In some embodiments, the insect powder comprises cholesterol in an amount ranging from 0.001-0.01 mg/100 gr of insect powder, 0.001-0.05 mg/100 gr of insect powder, 0.01-0.075 mg/100 gr of insect powder, 0.05-0.1 mg/100 gr of insect powder, 0.15-0.2 mg/100 gr of insect powder, 0.2-0.25 mg/100 gr of insect powder, 0.25-0.3 mg/100 gr of insect powder, or any value and range therebetween. Each possibility represents a separate embodiment of the invention.

In some embodiments, the composition further comprises one or more compounds. In some embodiments, the compound is a mineral. In some embodiments, the mineral is selected from the group consisting of: iron, phosphorus, potassium, sodium, and zinc.

As used herein, “one or more” comprises at least 2, at least 3, at least 4, at least 5, or any range therebetween. Each possibility represents a separate embodiment of the invention. In some embodiments, “one or more” comprises 2-3, 2-4, 2-5, 3-4, 3-5, or 4-5. Each possibility represents a separate embodiment of the invention.

In some embodiments, the insect powder further comprises iron in an amount ranging from 10-15 mg/100 gr of insect powder, 15-25 mg/100 gr of insect powder, 20-30 mg/100 gr of insect powder, 20-35 mg/100 gr of insect powder, 15-35 mg/100 gr of insect powder, or 30-40 mg/100 gr of insect powder. Each possibility represents a separate embodiment of the invention. In some embodiments, the insect powder further comprises iron in the amount of at least 10 mg/100 gr of insect powder, at least 12 mg/100 gr of insect powder, at least 15 mg/100 gr of insect powder, at least 17 mg/100 gr of insect powder, at least 20 mg/100 gr of insect powder, at least 25 mg/100 gr of insect powder, at least 30 mg/100 gr of insect powder, at least 35 mg/100 gr of insect powder, at least 40 mg/100 gr of insect powder, or any value or range therebetween. Each possibility represents a separate embodiment of the invention.

In some embodiments, the insect powder further comprises phosphorous in an amount ranging from 750-1,500 mg/100 gr of insect powder, 1,000-2,500 mg/100 gr of insect powder, 2,000-3,000 mg/100 gr of insect powder, 2,500-3,250 mg/100 gr of insect powder, 1,000-2,800 mg/100 gr of insect powder, or 2,750-3,250 mg/100 gr of insect powder. Each possibility represents a separate embodiment of the invention. In some embodiments, the insect powder further comprises phosphorous in the amount of at least 800 mg/100 gr of insect powder, at least 1,000 mg/100 gr of insect powder, at least 1,250 mg/100 gr of insect powder, at least 1,700 mg/100 gr of insect powder, at least 2,000 mg/100 gr of insect powder, at least 2,500 mg/100 gr of insect powder, at least 2,750 mg/100 gr of insect powder, or at least 3,000 mg/100 gr of insect powder, or any value or range therebetween. Each possibility represents a separate embodiment of the invention.

In some embodiments, the insect powder further comprises potassium in an amount ranging from 500-750 mg/100 gr of insect powder, 600-850 mg/100 gr of insect powder, 900-1,200 mg/100 gr of insect powder, 1,000-1,150 mg/100 gr of insect powder, 1,050-1,200 mg/100 gr of insect powder, or 1,200-1,500 mg/100 gr of insect powder. Each possibility represents a separate embodiment of the invention. In some embodiments, the insect powder further comprises potassium in the amount of at least 450 mg/100 gr of insect powder, at least 500 mg/100 gr of insect powder, at least 600 mg/100 gr of insect powder, at least 700 mg/100 gr of insect powder, at least 800 mg/100 gr of insect powder, at least 900 mg/100 gr of insect powder, at least 1,000 mg/100 gr of insect powder, at least 1,100 mg/100 gr of insect powder, at least 1,200 mg/100 gr of insect powder, at least 1,300 mg/100 gr of insect powder, or at least 1,400 mg/100 gr of insect powder, or any value or range therebetween. Each possibility represents a separate embodiment of the invention.

In some embodiments, the insect powder further comprises sodium in an amount ranging from 1-100 mg/100 gr of insect powder, 10-150 mg/100 gr of insect powder, 30-200 mg/100 gr of insect powder, 20-170 mg/100 gr of insect powder, 45-190 mg/100 gr of insect powder, 65-210 mg/100 gr of insect powder, 100-195 mg/100 gr of insect powder, 55-125 mg/100 gr of insect powder, 130-210 mg/100 gr of insect powder, 90-165 mg/100 gr of insect powder, 100-220 mg/100 gr of insect powder, 80-140 mg/100 gr of insect powder, or 1-250 mg/100 gr of insect powder. Each possibility represents a separate embodiment of the invention. In some embodiments, the insect powder comprises sodium in the amount of at least 60 mg/100 gr of insect powder, at least 70 mg/100 gr of insect powder, at least 80 mg/100 gr of insect powder, at least 90 mg/100 gr of insect powder, at least 100 mg/100 gr of insect powder, at least 110 mg/100 gr of insect powder, at least 120 mg/100 gr of insect powder, at least 130 mg/100 gr of insect powder, at least 140 mg/100 gr of insect powder, at least 150 mg/100 gr of insect powder, at least 160 mg/100 gr of insect powder, at least 170 mg/100 gr of insect powder, at least 180 mg/100 gr of insect powder, at least 190 mg/100 gr of insect powder, at least 200 mg/100 gr of insect powder, at least 225 mg/100 gr of insect powder, at least 250 mg/100 gr of insect powder, or any value or range therebetween. Each possibility represents a separate embodiment of the invention.

In some embodiments, the insect powder further comprises zinc in an amount ranging from 10-25 mg/100 gr of insect powder, 15-45 mg/100 gr of insect powder, 10-50 mg/100 gr of insect powder, 20-45 mg/100 gr of insect powder, 25-55 mg/100 gr of insect powder, or 30-55 mg/100 gr of insect powder. Each possibility represents a separate embodiment of the invention. In some embodiments, the insect powder further comprises iron in the amount of at least 10 mg/100 gr of insect powder, at least 15 mg/100 gr of insect powder, at least 20 mg/100 gr of insect powder, at least 25 mg/100 gr of insect powder, at least 30 mg/100 gr of insect powder, at least 35 mg/100 gr of insect powder, at least 40 mg/100 gr of insect powder, at least 45 mg/100 gr of insect powder, at least 50 mg/100 gr of insect powder, at least 60 mg/100 gr of insect powder, or any value or range therebetween. Each possibility represents a separate embodiment of the invention.

In some embodiments, the insect powder further comprises one or more fatty acids. In some embodiments, the fatty acid is selected from the group consisting of: saturated, monounsaturated, and polyunsaturated fatty acids.

As used herein, “one or more fatty acids” comprises 2-5, 3-8, 4-12, 3-15, 7-14, 8-13, or 6-15 types of fatty acids. Each possibility represents a separate embodiment of the invention. In some embodiments, “one or more fatty acids” comprises at least 2, at least 3, at least 4, at least 5, at least 6, at least 7, at least 8, at least 9, at least 10, at least 11, at least 12, at least 13, at least 14, at least 15 types of fatty acids, or any range therebetween. Each possibility represents a separate embodiment of the invention.

In some embodiments, the insect powder further comprises a monounsaturated fatty acid selected from: palmitoleic acid, oleic acid, cis-11-octadecanoic acid, and myristoleic acid. In some embodiments, the monounsaturated fatty acid is palmitoleic acid. In some embodiments, the insect powder further comprises palmitoleic acid.

In some embodiments, the insect powder further comprises fatty acids, wherein 25-70% by weight of fatty acids within the insect powder are monounsaturated fatty acids. In some embodiments, the insect powder further comprises fatty acids, wherein 35-65% by weight of fatty acids within the insect powder are monounsaturated fatty acids. In some embodiments, the insect powder further comprises fatty acids, wherein 40-60% by weight of fatty acids within the insect powder are monounsaturated fatty acids. In some embodiments, the insect powder further comprises fatty acids, wherein 45-55% by weight of fatty acids within the insect powder are monounsaturated fatty acids.

In some embodiments, the insect powder further comprises fatty acids, wherein 15-35% by weight of fatty acids within the insect powder are palmitoleic acid. In some embodiments, the insect powder further comprises fatty acids, wherein 15-30% by weight of fatty acids within the insect powder are palmitoleic acid. In some embodiments, the insect powder further comprises fatty acids, wherein 15-25% by weight of fatty acids within the insect powder are palmitoleic acid. In some embodiments, the insect powder further comprises fatty acids, wherein 20-35% by weight of fatty acids within the insect powder are palmitoleic acid. In some embodiments, the insect powder further comprises fatty acids, wherein 20-30% by weight of fatty acids within the insect powder are palmitoleic acid.

In some embodiments, the insect powder further comprises a polyunsaturated fatty acid. In some embodiments, the polyunsaturated fatty acid is linoleic acid, linolenic acid, or a combination thereof.

In some embodiments, the insect powder further comprises fatty acids, wherein 0.05-10% by weight of fatty acids within the insect powder are polyunsaturated fatty acids. In some embodiments, the insect powder further comprises fatty acids, wherein 0.1-10% by weight of fatty acids within the insect powder are polyunsaturated fatty acids. In some embodiments, the insect powder further comprises fatty acids, wherein 0.5-12% by weight of fatty acids within the insect powder are polyunsaturated fatty acids. In some embodiments, the insect powder further comprises fatty acids, wherein 0.5-10% by weight of fatty acids within the insect powder are polyunsaturated fatty acids. In some embodiments, the insect powder further comprises fatty acids, wherein 1-10% by weight of fatty acids within the insect powder are polyunsaturated fatty acids. In some embodiments, the insect powder further comprises fatty acids, wherein 1-8% by weight of fatty acids within the insect powder are polyunsaturated fatty acids. In some embodiments, the insect powder further comprises fatty acids, wherein 1-6% by weight of fatty acids within the insect powder are polyunsaturated fatty acids.

Methods for determining the amount and/or type of ingredients within a composition, such as described herein, would be apparent to one of ordinary skill in the art. Non-limiting examples of such methods include, but are not limited to: determination of fat content by instrument MQC-23-35 by pulsed NMR; determination of N-sub stances by Dumas method; determination of dry matter by gravimetric analysis; gravimetric determination of ash, determination of elements by atomic emission spectrometry with inductively coupled plasma and stoichiometric calculations of compounds concentration from measured values; determination of fatty acids by gas chromatography method (e.g., relative occurrence of fatty acids in fat) with FID detection, total amino acid content by HPLC, and/or others.

In some embodiments, the composition is an edible composition. In some embodiments, the composition is used in feeding a subject. In one embodiment, the subject is a human subject. In some embodiments, the subject is a non-human subject. Non-limiting examples of non-human subject include, but are not limited to, livestock, and fish.

According to some embodiments, the composition of the invention is formulated for oral administration. According to one embodiment, the composition further comprises an excipient, diluent or carrier suitable for oral consumption. According to another embodiment, the composition is formulated in a form selected from a capsule, dragee, pill, tablet, gel, liquid, slurry, suspension, syrup, a beverage, protein bar, and a pastry. In some embodiments, the composition is a foodstuff.

In certain embodiments, the composition is a solid composition formulated as tablets or powder mixture containing in addition to the insect powder suitable excipients including, but not limited to, starches, maltodextrins, gum arabic, calcium silicate, microcrystalline cellulose, polyvinylpyrrolidone, cellulose, water, syrup, and methylcellulose. The formulations can additionally include lubricating agents such as, for example, talc, and mineral oil; wetting agents; emulsifying and suspending agents; preserving agents such as methyl- and propyl hydroxybenzoates; sweetening agents; or flavoring agents. Polyols, buffers, and inert fillers may also be used. Examples of polyols include, but are not limited to: mannitol, sorbitol, xylitol, sucrose, maltose, glucose, lactose, dextrose, and the like. Suitable buffers encompass, but are not limited to, phosphate, citrate, tartrate, succinate, and the like. Other inert fillers, which may be used, encompass those which are known in the art and are useful in manufacturing.

Methods for producing insect powder or product are common and would be apparent to one of ordinary skill in the art. For example, a method for making insect products includes wet-grinding of at least one whole insect, at least one whole adult insect, or at least one whole live insect into an insect slurry; and drying the insect slurry to form a dried insect product comprising solid insect matter particles. The drying may include spray drying or drum drying. As used herein, “insect slurry” is a semiliquid mixture of ground non-dewatered insects with or without added liquid. The semiliquid mixture includes a pre-determined ratio of insects (mass) to added liquid (mass), such as water. For example, an insect slurry includes a 1:2 weight ratio of insects to water (e.g., 200 pounds (approx. 90.7 kg) of insects and 400 pounds (approx. 181.4 kg) of water). The step of drying may include heat drying, spray drying, freeze drying, tray drying, paddle drying, fluid bed drying, flash drying, air drying, vacuum drying, drum drying, or a combination thereof. Dryers, such as ovens, impingement ovens, freeze dryers, heat dryers, or hot air or vacuum dryers may be used. The spray drying is used to dry the insect slurry into a dried insect product. The drum drying is used to dry the insect slurry into a dried insect product. As used herein, “dried insect product” refers to an insect product (e.g., powder, flakes, meal) comprising water in an amount of about 15% by weight or less of the dried insect product. For example, the dried insect product comprises water in an amount of less than about 10% by weight.

Methods for obtaining whole insect or reduced fat insect powder would be apparent to one of ordinary skill in the art, and can include non-limiting steps, such as blanching, wet milling, oil separation, and drying for obtaining reduced fat insect powder, or blanching, drying, and milling for obtaining whole insect powder.

The advantages of wet-stage grinding include, for example: (1) reducing heat needed to preserve and dry the insect slurry; (2) minimizing/avoiding the negative effects heat has on the insect product properties; (3) increasing process efficiency; (4) improving product digestibility; and (5) improving process throughputs.

The wet-grinding process may be performed using any one of or a combination of the following devices: grinders, mills, stone mills, mixers, peanut grinders, peanut butter grinders, colloid mills, pin mills, bead mills, dispersers, homogenizers, choppers, rotor stator devices, hammer mills, press grinders, mashers, macerators, food processors, rollers, or juicers. Non-limiting examples of grinders include, but are not limited to, Olde Tyme Peanut Mill, Olde Tyme Peanut Grinder, Olde Tyme Peanut butter Grinder, Olde Tyme Peanut butter Mill, Old Style Peanut Mill, Olde Style Peanut Grinder, Olde Style Peanut butter Grinder, Olde Style Peanut butter Mill, IKA mixer, IKA colloid mill, Jack LaLanne Power Juicer or an Acme 6001 Centrifugal Juicer.

Any concentration ranges, percentage range, or ratio range recited herein are to be understood to include concentrations, percentages or ratios of any integer within that range and fractions thereof, such as one tenth and one hundredth of an integer, unless otherwise indicated.

Any number range recited herein relating to any physical feature, such as weight, is to be understood to include any integer within the recited range, unless otherwise indicated.

In the discussion unless otherwise stated, adjectives such as “substantially” and “about” modifying a condition or relationship characteristic of a feature or features of an embodiment of the invention, are understood to mean that the condition or characteristic is defined to within tolerances that are acceptable for operation of the embodiment for an application for which it is intended. Unless otherwise indicated, the word “or” in the specification and claims is considered to be the inclusive “or” rather than the exclusive or, and indicates at least one of, or any combination of items it conjoins.

It should be understood that the terms “a” and “an” as used above and elsewhere herein refer to “one or more” of the enumerated components. It will be clear to one of ordinary skill in the art that the use of the singular includes the plural unless specifically stated otherwise. Therefore, the terms “a”, “an” and “at least one” are used interchangeably in this application.

For purposes of better understanding the present teachings and in no way limiting the scope of the teachings, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that may vary depending upon the desired properties sought to be obtained. At the very least, each numerical parameter should at least be construed in light of the number of reported significant digits and by applying ordinary rounding techniques.

In the description and claims of the present application, each of the verbs, “comprise”, “include” and “have” and conjugates thereof, are used to indicate that the object or objects of the verb are not necessarily a complete listing of components, elements or parts of the subject or subjects of the verb.

Other terms as used herein are meant to be defined by their well-known meanings in the art.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

### Examples

Specification of different ingredients from
the Mediterranean fruit fly C. capitata

| | | |
|---|---|---|
| | Reduced fat protein | Whole larvae |
| Component | powder (non-soluble) | powder |

Nutritional Panel

| | | |
|---|---|---|
| Dry matter (%) | 94.45-97.6 | 95.47-97.3 |
| Moisture (%) | 2.44-5.55 | 2.96-4.53 |
| Crude Protein (%) | 60.51-71 | 42.64-48.3 |
| Carbohydrates (%) | 4.37-16.87 | 11.8-32.5 |
| Chitin (%) | 6.59-7.04 | 3.79 |
| Trehalose (%) | 0.7-0.8 | 2.2 |
| Ash (Minerals) (%) | 5.21-13.0 | 4.45-6.59 |
| Fat (%) | 7.95-12.3 | 18.75-34.33 |
| Saturated fat (%) | 3.45-4.51 | 13.2 |
| Mono-unsaturated fat (%) | 4.06-6.94 | 16.2 |
| Poly-unsaturated fat (%) | 0.31-0.9 | 0.44 |
| Cholesterol (mg/100 g) | 0-0.237 | <0.2 |
| Energy (kcal/100 g) | 319-456 | 470-527 |

Minerals (mg/100 g)

| | | |
|---|---|---|
| Calcium | 1,120-3,090 | 842 |
| Iron | 24.6-32 | 18.9 |
| Magnesium | 236-846 | 265 |
| Phosphorus | 1,150-2,540 | 1,100 |
| Potassium | 510-558 | 1,270 |
| Sodium | 75-96.9 | 166 |
| Zinc | 15-38.4 | 25.1 |

Amino Acids (g/100 g)

| | | |
|---|---|---|
| Aspartic Acid | 5.91-6.36 | 5.04 |
| Serine | 3.13-3.73 | 2.48 |
| Glutamic acid | 7.57-8.62 | 7.48 |
| Glycine | 2.46-2.9 | 2.64 |
| Histidine | 1.39-1.59 | 1.48 |
| Arginine | 3.45-3.82 | 3.32 |
| Threonine | 2.66-3.03 | 2.8 |
| Alanine | 3.65-4.11 | 3.6 |
| Proline | 2.77-3.12 | 2.04 |
| Cystine | 0.50-0.59 | 0.4 |
| Tyrosine | 3.66-3.92 | 3.28 |
| Valine | 3.2-3.91 | 2.76 |
| Methionine | 1.29-1.35 | 1.56 |
| Lysine | 4.47-5.23 | 3.88 |
| Isoleucine | 2.75-3.23 | 1.84 |
| Leucine | 4.28-4.7 | 3.2 |
| Phenylalanine | 2.66-2.92 | 2.04 |
| Tryptophan | 0.80 | |

Fatty Acids (%)

| | | |
|---|---|---|
| Butyric acid (C4:0) | 0.18-0.24 | 0.49 |
| Caproic acid (C6:0) | 0 | 0 |
| Capric acid (C10:0) | 0.14-0.19 | 0.22 |
| Lauric acid (C12:0) | 0.93-0.98 | 1.41 |
| Myristic acid (C14:0) | 2.36-2.43 | 2.98 |
| Myristoleic acid (C14:1) | 0.34-0.38 | 0.45 |
| Palmitic acid (C16:0) | 29.5-31.7 | 34.1 |
| Palmitoleic acid (C16:1) | 23.1-27.1 | 26.9 |
| Stearic acid (C18:0) | 3.01-3.48 | 2.77 |
| Oleic acid (C18:1n9c) | 22.5-28.2 | 24.1 |
| Cis-11-Octadecanoic acid | 0.32-0.65 | 0.54 |
| (C18:1n11c) | | |
| Linoleic acid (C18:2n6c) | 1.83-9.46 | 1.07 |
| Linolenic acid (C18:3n3c) | 0-0.68 | 0.35 |
| Arachidic acid (C20:0) | 0.23-0.26 | 0.17 |
| Heneicosanoic acid (C21:0) | 0 | 0 |

Physical Properties

| | | |
|---|---|---|
| Color and appearance | Beige powder | Tan powder |
| Density (kg/L) | 0.53 | |

The reduced fat protein insect powder (non-soluble) and the whole larvae insect powder were found to be significantly rich with calcium and magnesium.

While certain features of the invention have been described herein, many modifications, substitutions, changes, and equivalents will now occur to those of ordinary skill in the art. It is, therefore, to be understood that the appended claims are intended to cover all such modifications and changes as fall within the true spirit of the invention.

1. A composition comprising an insect powder comprising calcium at a concentration of 800-3,200 mg/100 gr insect powder; magnesium at a concentration of 230-900 mg/100 gr insect powder, or a combination thereof.

2. The composition of claim 1, further comprising a protein in an amount of 40-80% by weight of said insect powder.

3. The composition of claim 1, further comprising cholesterol in an amount of less than 0.25 mg/100 gr of said insect powder.

4. The composition of claim 1, further comprising one or more compounds selected from the group consisting of: iron, phosphorus, potassium, sodium, and zinc.

5. The composition of claim 4, wherein said iron is present in an amount of 15-35 mg/100 gr of said insect powder.

6. The composition of claim 4, wherein said phosphorus is present in an amount of 1,000-2,800 mg/100 gr of said insect powder.

7. The composition of claim 4, wherein said potassium is present in an amount of 500-1,300 mg/100 gr of said insect powder.

8. The composition of claim 4, wherein said sodium is present in an amount of 1-200 mg/100 gr of said insect powder.

9. The composition of claim 4, wherein said zinc is present in an amount of 10-50 mg/100 gr of said insect powder.

10. The composition of claim 1, further comprising one or more fatty acids selected from the group consisting of: monounsaturated and polyunsaturated fatty acids.

11. The composition of claim 10, wherein said monounsaturated fatty acid is selected from the group consisting of: palmitoleic acid, oleic acid, cis-11-octadecanoic acid, and myristoleic acid.

12. The composition of claim 10, wherein said monounsaturated fatty acid is palmitoleic acid.

13. The composition of claim 10, wherein 25-60% by weight of fatty acids within said insect powder are monosaturated fatty acids.

14. The composition of claim 10, wherein 15-35% by weight of fatty acids within said insect powder are palmitoleic acid.

15. The composition of claim 10, wherein said polyunsaturated fatty acid is any one of linoleic acid and linolenic acid.

16. The composition of claim 10, wherein 0.1-10% by weight of fatty acids within said insect powder are polyunsaturated fatty acids.

17. The composition of claim 1, wherein said powder comprises any one of: an extract, a homogenate, fractions thereof, and any combination thereof, being derived from said insect.

18. The composition of claim 1, wherein said insect powder is derived from any one of: a whole adult insect, an egg thereof, a larvae thereof, any portions thereof, and any combination thereof.

19. The composition of claim 1, wherein said insect is Bactrocera dorsalis or Ceratitis capitata.

20. The composition of claim 1, being an edible composition.
